(19) United States
(12) Patent Application Publication
(10) Pub. No.: US 2013/0163501 A1
(43) Pub. Date: Jun. 27, 2013

(54) FLEXIBLE CYCLIC PREFIX MANAGEMENT

(71) Applicant: QUALCOMM Incorporated, San Diego, CA (US)

(72) Inventors: Wanshi Chen, San Diego, CA (US); Peter Gaal, San Diego, CA (US); Tao Luo, San Diego, CA (US); Jelena M. Damnjanovic, Del Mar, CA (US)

(73) Assignee: QUALCOMM Incorporated, San Diego, CA (US)

(21) Appl. No.: 13/722,639

(22) Filed: Dec. 20, 2012

Related U.S. Application Data
(60) Provisional application No. 61/579,223, filed on Dec. 22, 2011.

(51) Int. Cl. H04W 72/04

(52) U.S. Cl. 370/312; 370/329

(57) ABSTRACT

Aspects of the present disclosure provide techniques for managing cyclic prefixes (CPs). The techniques may involve utilizing different CP types for different portions within a same subframe. Various mechanisms may be used to determine which CP types are used for which portions.

### CLAIM OF PRIORITY UNDER 35 U.S.C. §119

The present Application for Patent claims benefit of U.S. Provisional Patent Application Ser. No. 61/579,223, filed Dec. 22, 2011 and assigned to the assignee hereof and hereby expressly incorporated by reference herein.

### BACKGROUND

1. Field

Aspects of the present disclosure relate generally to wireless communication systems, and more particularly, to flexible cyclic prefix (CP) management in wireless communications systems.

2. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

### SUMMARY

In an aspect, a method for wireless communications is provided. The method generally includes exchanging data with a user equipment in uplink and downlink subframes, wherein, for at least one of the subframes, different cyclic prefix (CP) types are used within the same subframe, determining, for subframes in which said different CP types are used, which said CP types are used for which portions, and processing the subframes in which said different CP types are used, based on the determination.

In an aspect, an apparatus for wireless communications is provided. The apparatus generally includes means for exchanging data with a base station in uplink and downlink subframes, wherein, for at least one of the subframes, different cyclic prefix (CP) types are used within the same subframe, means for determining, for subframes in which said different CP types are used, which said CP types are used for which portions, and means for processing the subframes in which said different CP types are used, based on the determination.

In an aspect, an apparatus for wireless communications is provided. The apparatus generally includes means for exchanging data with a user equipment in uplink and downlink subframes, wherein, for at least one of the subframes, different cyclic prefix (CP) types are used within the same subframe, means for determining, for subframes in which said different CP types are used, which said CP types are used for which portions, and means for processing the subframes in which said different CP types are used, based on the determination.

In an aspect, a base station is provided. The base station generally includes at least one processor and a memory coupled to the at least one processor, wherein the processor is generally configured for exchanging data with a user equipment in uplink and downlink subframes, wherein, for at least one of the subframes, different cyclic prefix (CP) types are used within the same subframe, means for determining, for subframes in which said different CP types are used, which said CP types are used for which portions, and means for processing the subframes in which said different CP types are used, based on the determination.

In an aspect, a computer program product comprising a computer-readable medium having instructions stored thereon is provided. The instructions are generally executable by one or more processors for exchanging data with a base station in uplink and downlink subframes, wherein, for at least one of the subframes, different cyclic prefix (CP) types are used within the same subframe, determining, for subframes in which said different CP types are used, which said CP types are used for which portions, and processing the subframes in which said different CP types are used, based on the determination.

In an aspect, a computer program product comprising a computer-readable medium having instructions stored thereon is provided. The instructions are generally executable by one or more processors for exchanging data with a user equipment in uplink and downlink subframes, wherein, for at least one of the subframes, different cyclic prefix (CP) types are used within the same subframe, determining, for subframes in which said different CP types are used, which said CP types are used for which portions, and processing the subframes in which said different CP types are used, based on the determination.

Various aspects and features of the disclosure are described in further detail below.

### BRIEF DESCRIPTION OF THE DRAWINGS

FIG. 1 is a block diagram conceptually illustrating an example of a telecommunications system;

FIG. 2 is a block diagram conceptually illustrating an example of a down link frame structure in a telecommunications system;

FIG. 3 is a block diagram conceptually illustrating a design of a base station/eNodeB and a UE configured according to one aspect of the present disclosure;

FIG. 4A discloses a continuous carrier aggregation type;

FIG. 4B discloses a non-continuous carrier aggregation type;

FIG. 5 discloses MAC layer data aggregation;

FIG. 6 is a block diagram illustrating a method for controlling radio links in multiple carrier configurations;

FIGS. 7A-D illustrate various example configurations of flexible cyclic prefix management on the downlink;

FIGS. 8A-C illustrate various example configurations of flexible cyclic prefix management on the uplink;

FIGS. 9A and 9B illustrate example configurations of cyclic prefix management for carrier segments of Multimedia Broadcast Single Frequency Network (MBSFN);

FIGS. 10A and 10B illustrate additional example configurations of cyclic prefix management for carrier segments of Multimedia Broadcast Single Frequency Network (MBSFN).

FIG. 11 illustrates example operations that may be performed by a user equipment, in accordance with aspects of the present disclosure.

FIG. 12 illustrates example operations that may be performed by a base station, in accordance with aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

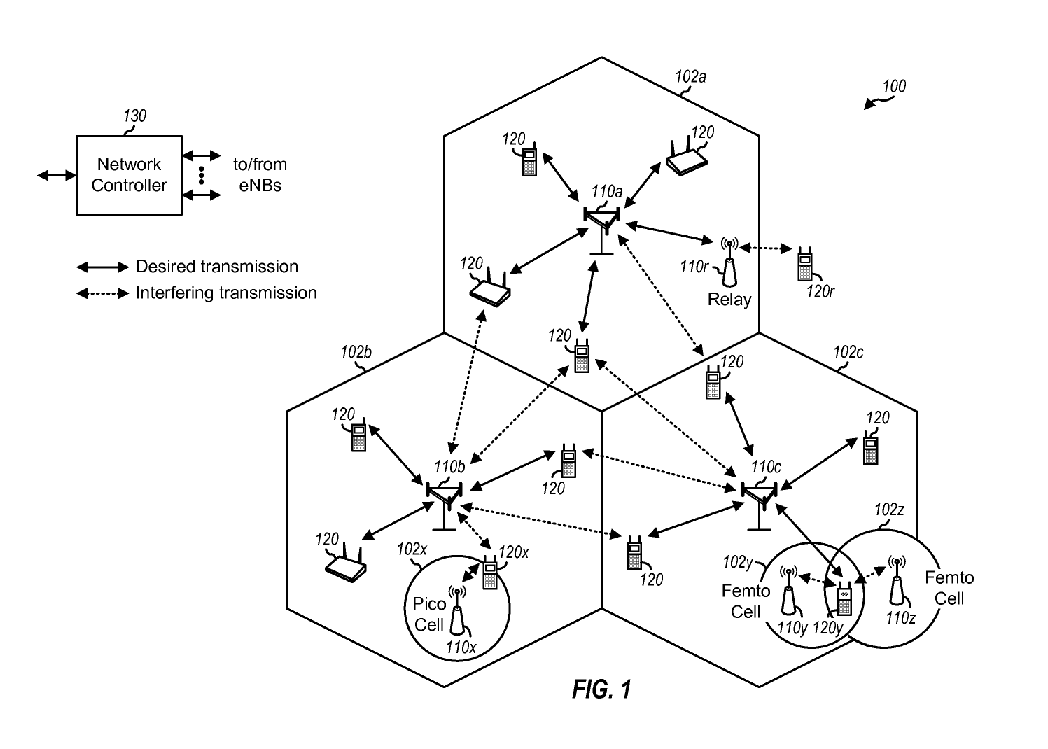

FIG. 1 shows a wireless communication network 100, which may be an LTE network. The wireless network 100 may include a number of evolved Node Bs (eNodeBs) 110 and other network entities. An eNodeB may be a station that communicates with the UEs and may also be referred to as a base station, an access point, etc. A Node B is another example of a station that communicates with the UEs.

Each eNodeB 110 may provide communication coverage for a particular geographic area. In 3GPP, the term “cell” can refer to a coverage area of an eNodeB and/or an eNodeB subsystem serving this coverage area, depending on the context in which the term is used.

An eNodeB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNodeB for a macro cell may be referred to as a macro eNodeB. An eNodeB for a pico cell may be referred to as a pico eNodeB. An eNodeB for a femto cell may be referred to as a femto eNodeB or a home eNodeB. In the example shown in FIG. 1, the eNodeBs 110a, 110b and 110c may be macro eNodeBs for the macro cells 102a, 102b and 102c, respectively. The eNodeB 110x may be a pico eNodeB for a pico cell 102x. The eNodeBs 110y and 110z may be femto eNodeBs for the femto cells 102y and 102z, respectively. An eNodeB may support one or multiple (e.g., three) cells.

The wireless network 100 may also include relay stations. A relay station is a station that receives a transmission of data and/or other information from an upstream station (e.g., an eNodeB or a UE) and sends a transmission of the data and/or other information to a downstream station (e.g., a UE or an eNodeB). A relay station may also be a UE that relays transmissions for other UEs. In the example shown in FIG. 1, a relay station 110r may communicate with the eNodeB 110a and a UE 120r in order to facilitate communication between the eNodeB 110a and the UE 120r. A relay station may also be referred to as a relay eNodeB, a relay, etc.

The wireless network 100 may be a heterogeneous network that includes eNodeBs of different types, e.g., macro eNodeBs, pico eNodeBs, femto eNodeBs, relays, etc. These different types of eNodeBs may have different transmit power levels, different coverage areas, and different impact on interference in the wireless network 100. For example, macro eNodeBs may have a high transmit power level (e.g., 20 Watts) whereas pico eNodeBs, femto eNodeBs and relays may have a lower transmit power level (e.g., 1 Watt).

The wireless network 100 may support synchronous or asynchronous operation. For synchronous operation, the eNodeBs may have similar frame timing, and transmissions from different eNodeBs may be approximately aligned in time. For asynchronous operation, the eNodeBs may have different frame timing, and transmissions from different eNodeBs may not be aligned in time. The techniques described herein may be used for both synchronous and asynchronous operation.

A network controller 130 may couple to a set of eNodeBs and provide coordination and control for these eNodeBs. The network controller 130 may communicate with the eNodeBs 110 via a backhaul. The eNodeBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, etc. A UE may be able to communicate with macro eNodeBs, pico eNodeBs, femto eNodeBs, relays, etc. In FIG. 1, a solid line with double arrows indicates desired transmissions between a UE and a serving eNodeB, which is an eNodeB designated to serve the UE on the downlink and/or uplink. A dashed line with double arrows indicates interfering transmissions between a UE and an eNodeB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a ‘resource block’) may be 12 subcarriers (or 180 kHz). Consequently, the nominal FFT size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

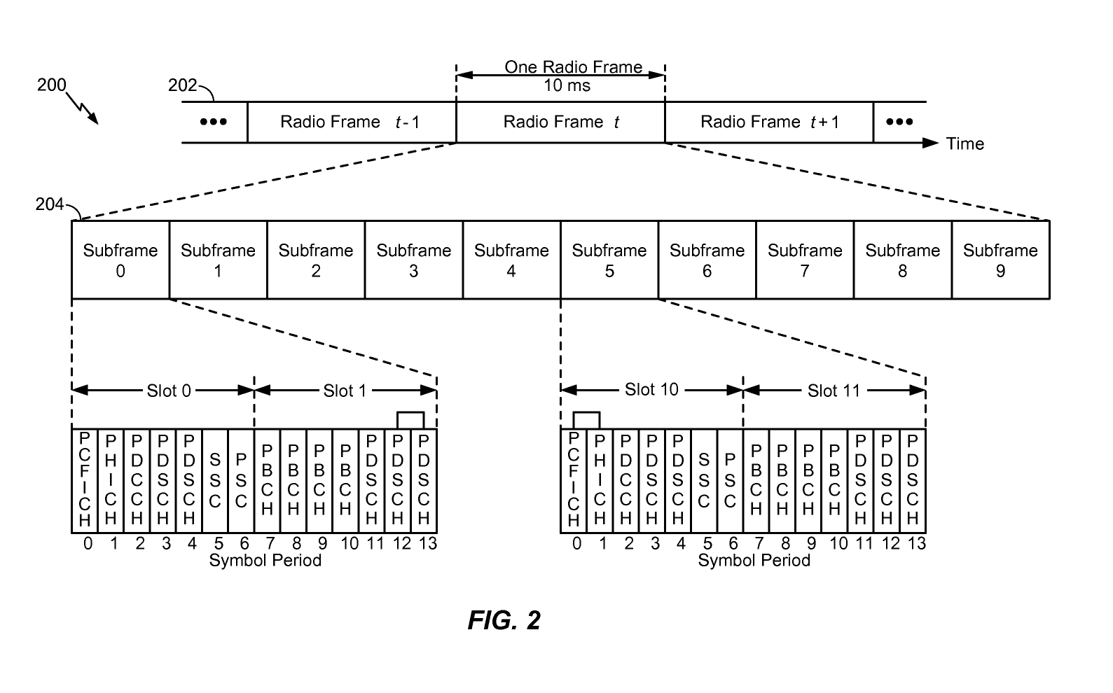

FIG. 2 shows a down link frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (as shown in FIG. 2) or 14 symbol periods for an extended cyclic prefix. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNodeB may send a primary synchronization signal (PSS) and a secondary synchronization signal (SSS) for each cell in the eNodeB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNodeB may send a Physical Broadcast Channel (PBCH) in symbol periods 0 to 3 in slot 1 of subframe 0. The PBCH may carry certain system information.

The eNodeB may send a Physical Control Format Indicator Channel (PCFICH) in only a portion of the first symbol period of each subframe, although depicted in the entire first symbol period in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNodeB may send a Physical HARQ Indicator Channel (PHICH) and a Physical Downlink Control Channel (PDCCH) in the first M symbol periods of each subframe (M=3 in FIG. 2). The PHICH may carry information to support hybrid automatic retransmission (HARQ). The PDCCH may carry information on uplink and downlink resource allocation for UEs and power control information for uplink channels. Although not shown in the first symbol period in FIG. 2, it is understood that the PDCCH and PHICH are also included in the first symbol period. Similarly, the PHICH and PDCCH are also both in the second and third symbol periods, although not shown that way in FIG. 2. The eNodeB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNodeB may send the PSS, SSS and PBCH in the center 1.08 MHz of the system bandwidth used by the eNodeB. The eNodeB may send the PCFICH and PHICH across the entire system bandwidth in each symbol period in which these channels are sent. The eNodeB may send the PDCCH to groups of UEs in certain portions of the system bandwidth. The eNodeB may send the PDSCH to specific UEs in specific portions of the system bandwidth. The eNodeB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNodeB may send the PDCCH to the UE in any of the combinations that the UE will search.

A UE may be within the coverage of multiple eNodeBs. One of these eNodeBs may be selected to serve the UE. The serving eNodeB may be selected based on various criteria such as received power, path loss, signal-to-noise ratio (SNR), etc.

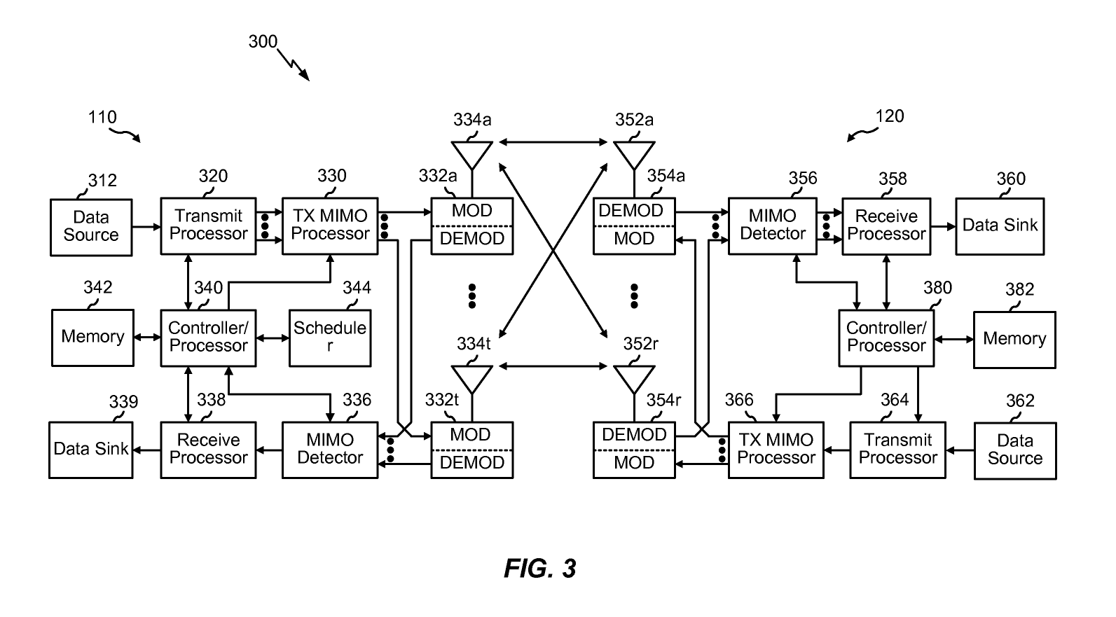

FIG. 3 shows a block diagram of a design of a base station/eNodeB 110 and a UE 120, which may be one of the base stations/eNodeBs and one of the UEs in FIG. 1. For a restricted association scenario, the base station 110 may be the macro eNodeB 110c in FIG. 1, and the UE 120 may be the UE 120y. The base station 110 may also be a base station of some other type. The base station 110 may be equipped with antennas 334a through 334t, and the UE 120 may be equipped with antennas 352a through 352r.

At the base station 110, a transmit processor 320 may receive data from a data source 312 and control information from a controller/processor 340. The control information may be for the PBCH, PCFICH, PHICH, PDCCH, etc. The data may be for the PDSCH, etc. The processor 320 may process (e.g., encode and symbol map) the data and control information to obtain data symbols and control symbols, respectively. The processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the base station 110 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The transmit processor 364 may also generate reference symbols for a reference signal. The symbols from the transmit processor 364 may be precoded by a TX MIMO processor 366 if applicable, further processed by the demodulators 354a through 354r (e.g., for SC-FDM, etc.), and transmitted to the base station 110. At the base station 110, the uplink signals from the UE 120 may be received by the antennas 334, processed by the modulators 332, detected by a MIMO detector 336 if applicable, and further processed by a receive processor 338 to obtain decoded data and control information sent by the UE 120. The receive processor 338 may provide the decoded data to a data sink 339 and the decoded control information to the controller/processor 340.

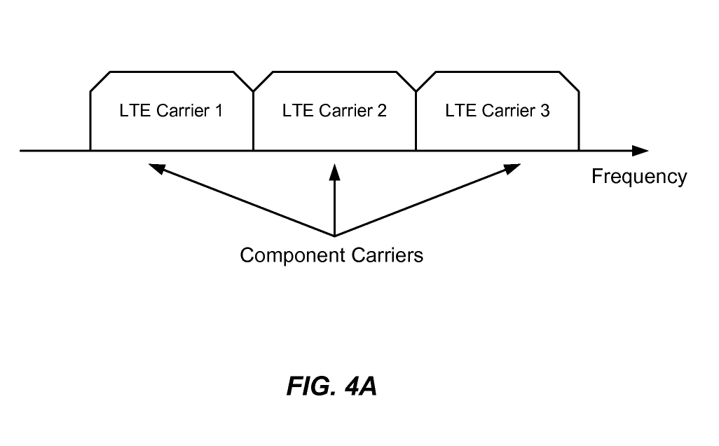

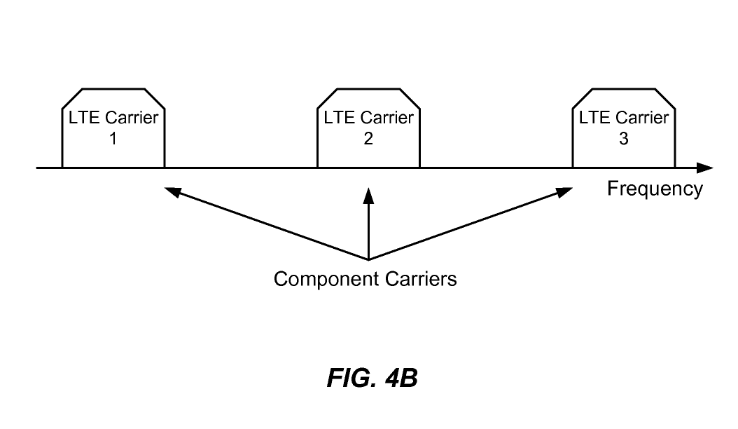

The controllers/processors 340 and 380 may direct the operation at the base station 110 and the UE 120, respectively. The processor 340 and/or other processors and modules at the base station 110 may perform or direct the execution of various processes for the techniques described herein. The processor 380 and/or other processors and modules at the UE 120 may also perform or direct the execution of the functional blocks illustrated in FIGS. 4A, 4B, 5 and 6, and/or other processes for the techniques described herein. The memories 342 and 382 may store data and program codes for the base station 110 and the UE 120, respectively. A scheduler 344 may schedule UEs for data transmission on the downlink and/or uplink.

In one configuration, the UE 120 for wireless communication includes means for detecting interference from an interfering base station during a connection mode of the UE, means for selecting a yielded resource of the interfering base station, means for obtaining an error rate of a physical downlink control channel on the yielded resource, and means, executable in response to the error rate exceeding a predetermined level, for declaring a radio link failure. In one aspect, the aforementioned means may be the processor(s), the controller/processor 380, the memory 382, the receive processor 358, the MIMO detector 356, the demodulators 354a, and the antennas 352a configured to perform the functions recited by the aforementioned means. In another aspect, the aforementioned means may be a module or any apparatus configured to perform the functions recited by the aforementioned means.

### Carrier Aggregation

LTE-Advanced UEs use spectrum up to 20 Mhz bandwidths allocated in a carrier aggregation of up to a total of 100 Mhz (5 component carriers) used for transmission in each direction. Generally, less traffic is transmitted on the uplink than the downlink, so the uplink spectrum allocation may be smaller than the downlink allocation. For example, if 20 Mhz is assigned to the uplink, the downlink may be assigned 100 Mhz. These asymmetric FDD assignments will conserve spectrum and are a good fit for the typically asymmetric bandwidth utilization by broadband subscribers.

### Carrier Aggregation Types

For the LTE-Advanced mobile systems, two types of carrier aggregation (CA) methods have been proposed, continuous CA and non-continuous CA. They are illustrated in FIGS. 4A and 4B. Non-continuous CA occurs when multiple available component carriers are separated along the frequency band (FIG. 4B). On the other hand, continuous CA occurs when multiple available component carriers are adjacent to each other (FIG. 4A). Both non-continuous and continuous CA aggregate multiple LTE/component carriers to serve a single unit of LTE Advanced UE.

Multiple RF receiving units and multiple FFTs may be deployed with non-continuous CA in LTE-Advanced UE since the carriers are separated along the frequency band. Because non-continuous CA supports data transmissions over multiple separated carriers across a large frequency range, propagation path loss, Doppler shift and other radio channel characteristics may vary a lot at different frequency bands.

Thus, to support broadband data transmission under the non-continuous CA approach, methods may be used to adaptively adjust coding, modulation and transmission power for different component carriers. For example, in an LTE-Advanced system where the enhanced NodeB (eNodeB) has fixed transmitting power on each component carrier, the effective coverage or supportable modulation and coding of each component carrier may be different.

### Data Aggregation Schemes

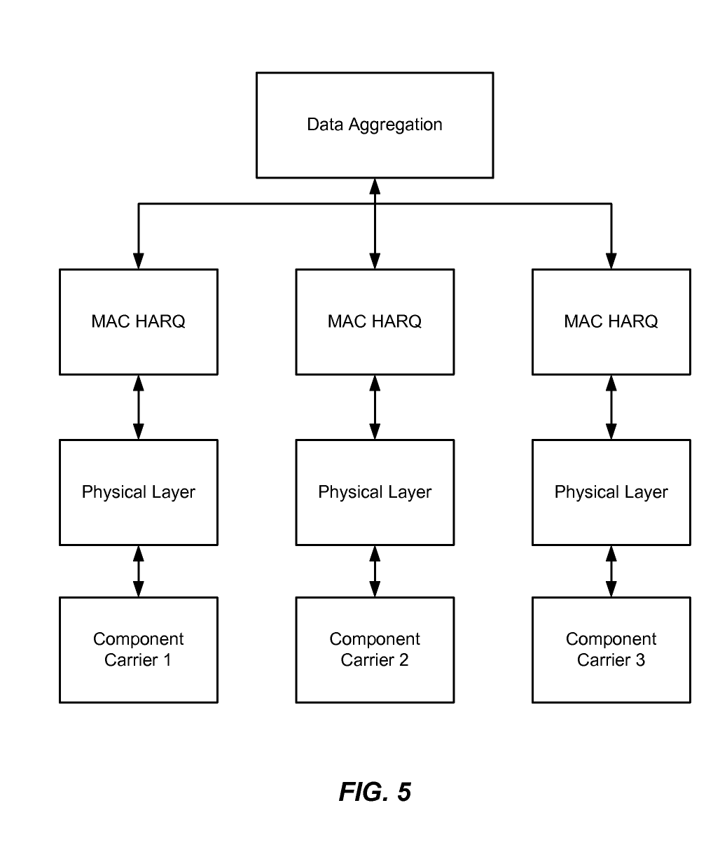

FIG. 5 illustrates aggregating transmission blocks (TBs) from different component carriers at the medium access control (MAC) layer (FIG. 5) for an IMT-Advanced system. With MAC layer data aggregation, each component carrier has its own independent hybrid automatic repeat request (HARQ) entity in the MAC layer and its own transmission configuration parameters (e.g., transmitting power, modulation and coding schemes, and multiple antenna configuration) in the physical layer. Similarly, in the physical layer, one HARQ entity is provided for each component carrier.

### Control Signaling

In general, there are three different approaches for deploying control channel signaling for multiple component carriers. The first involves a minor modification of the control structure in LTE systems where each component carrier is given its own coded control channel.

The second method involves jointly coding the control channels of different component carriers and deploying the control channels in a dedicated component carrier. The control information for the multiple component carriers will be integrated as the signaling content in this dedicated control channel. As a result, backward compatibility with the control channel structure in LTE systems is maintained, while signaling overhead in the CA is reduced.

Multiple control channels for different component carriers are jointly coded and then transmitted over the entire frequency band formed by a third CA method. This approach offers low signaling overhead and high decoding performance in control channels, at the expense of high power consumption at the UE side. However, this method is not compatible with LTE systems.

### Handover Control

It is preferable to support transmission continuity during the handover procedure across multiple cells when CA is used for IMT-Advanced UE. However, reserving sufficient system resources (i.e., component carriers with good transmission quality) for the incoming UE with specific CA configurations and quality of service (QoS) requirements may be challenging for the next eNodeB. The reason is that the channel conditions of two (or more) adjacent cells (eNodeBs) may be different for the specific UE. In one approach, the UE measures the performance of only one component carrier in each adjacent cell. This offers similar measurement delay, complexity, and energy consumption as that in LTE systems. An estimate of the performance of the other component carriers in the corresponding cell may be based on the measurement result of the one component carrier. Based on this estimate, the handover decision and transmission configuration may be determined.

According to various embodiments, the UE operating in a multicarrier system (also referred to as carrier aggregation) is configured to aggregate certain functions of multiple carriers, such as control and feedback functions, on the same carrier, which may be referred to as a “primary carrier.” The remaining carriers that depend on the primary carrier for support are referred to as associated secondary carriers. For example, the UE may aggregate control functions such as those provided by the optional dedicated channel (DCH), the nonscheduled grants, a physical uplink control channel (PUCCH), and/or a physical downlink control channel (PDCCH). Signaling and payload may be transmitted both on the downlink by the eNode B to the UE, and on the uplink by the UE to the eNode B.

In some embodiments, there may be multiple primary carriers. In addition, secondary carriers may be added or removed without affecting the basic operation of the UE, including physical channel establishment and RLF procedures which are layer 2 procedures, such as in the 3GPP technical specification 36.331 for the LTE RRC protocol.

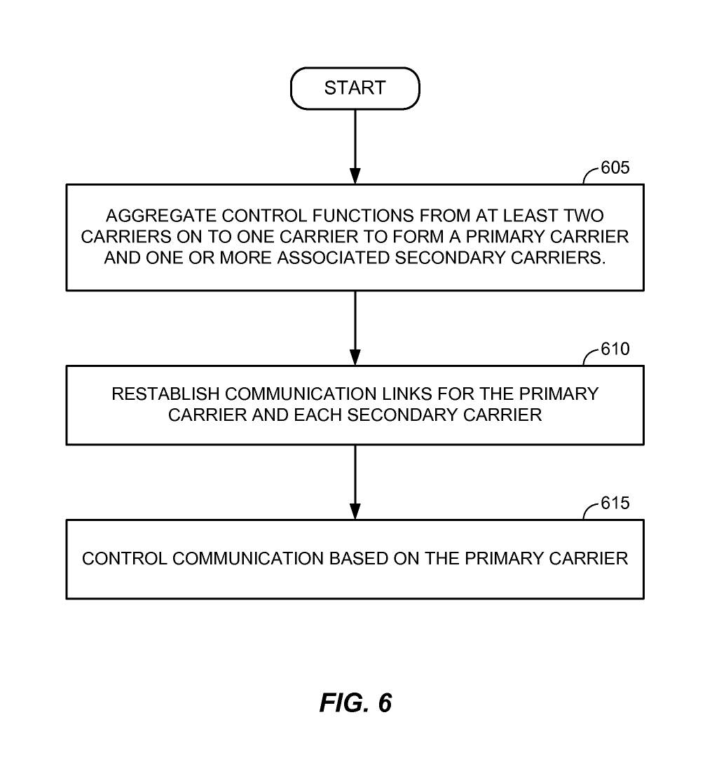

FIG. 6 illustrates a method 600 for controlling radio links in a multiple carrier wireless communication system by grouping physical channels according to one example. As shown, the method includes, at block 605, aggregating control functions from at least two carriers onto one carrier to form a primary carrier and one or more associated secondary carriers. Next at block, 610, communication links are established for the primary carrier and each secondary carrier. Then, communication is controlled based on the primary carrier in block 615.

### Flexible Cyclic Prefix Management

In some cases, it may be desirable for wireless communications systems, such as Long Term Evolution-Advanced (LTE-A), to support uplink (UL) Coordinated Multi-Point (CoMP) transmission and reception. In general, CoMP seeks to improve system performance by dynamically coordinating transmission and/or reception at multiple geographically separated sites.

With uplink CoMP, processing for a UE may involve two or more base stations (e.g., LTE or LTE-A eNBs). Uplink CoMP reception typically involves jointly receiving a transmitted signal at multiple geographically separated points. With joint reception, the signals received at multiple sites are jointly processed for improved reception performance. To control interference, scheduling decisions may be coordinated among cells. In different examples, the cooperating units can be any type of reception points, such as separate remote radio heads (RRHs), eNBs, relays, and the like.

Joint transmission involves transmitting data to a mobile terminal jointly from several sites (transmission points). As a result, there may be not only an increase in the received power, but also a reduction in the interference.

With CoMP, when a UE is in the cell-edge region, it may be able to transmit to multiple cell sites and receive signals from multiple cell sites, regardless of the system load. As a result, if the signaling transmitted from the multiple cell sites is coordinated, performance on the DL may be improved. On the UL, the signal may be received by multiple cell sites. Improvement in performance on the UL may occur if the scheduling is coordinated from the different cell sites.

UL CoMP is beneficial especially for cell edge UEs, because the UL CoMP effectively converts the “interfering” eNBs to “coordinated” eNBs (these coordinated eNBs are either directly or indirectly involved in the UL processing). However, the delay spread may be effectively increased (for example, relative to in the absence of CoMP) due to the difference in channel conditions and propagation delays in the different cells involved in CoMP. This may present a challenge, particular since the UL timing for the UE is typically tied with one cell. This larger delay spread may cause performance degradation and, to some extent, compromise the benefits of CoMP.

Cyclic prefixes (CPs) may be used in wireless systems, such as LTE, to mitigate inter-symbol-interference (ISI) and ensure orthogonality among UL signals. The cyclic prefix appended to each OFDM symbol (DL) or each SC-FDM symbol (UL) may be used to combat intersymbol interference (ISI) caused by delay spread in a multipath channel (i.e., a signal transmitted by a cell may reach a UE via multiple signal paths). Delay spread generally refers to the difference between the earliest and latest arriving signal copies at the UE on the multiple signal paths.

To effectively combat ISI, a cyclic prefix (CP) length may be selected to be equal to or greater than the expected delay spread so that the CP contains a significant portion of all multipath energies. The CP represents a fixed overhead of C samples for each OFDM or SC-FDM symbol. There are two types of CPs defined in LTE, normal CP and extended CP which correspond to seven and six OFDM symbols per slot, respectively. A Normal CP is roughly 4.7 usec, while an Extended CP is roughly 16.7 usec.

Normal CP is substantially more efficient than extended CP (roughly 20% more efficient) due to lower overhead. However, in environments with large delay spread, it may be beneficial to use extended CP for some UEs in CoMP.

Further, while time tracking in LTE is based on cell specific reference signals (CRS), in LTE-A, time tracking at a UE may be based on reference signals other than CRS. CRS were introduced in release 8 of LTE and are LTE's most basic downlink reference signal. They are transmitted in every resource block in the frequency domain and in every downlink subframe. For one, two, or four corresponding antenna ports, there can be one, two or four corresponding cell-specific reference signals in a cell. CRS may be used by remote terminals to estimate channels for coherent demodulation. CRS are wide-band, and are present in all subframes, which provide reliable time tracking.

In some cases, however, CRS may either become unavailable or inappropriate. For example, CRS may not be present in some subframes and/or carriers. Also, CRS may come from a different cell than the cell the UE receives PDSCH, making it inappropriate for time tracking. For these reasons, other reference signal (RS) types may be used for time tracking, such as UE specific RS, channel state information reference signals (CSI-RS), or the like.

These RS types may have low density (in frequency and/or time) and/or be narrowband, which may result in compromised time tracking performance. This, in turn, may result in ISI and performance degradation, especially when the number of RBs is small (for both PDSCH and ePDCCH). It may then be helpful to use extended CP for some UEs for improved performance and simpler implementation.

Currently in LTE, the CP is configured on a “per-cell” basis, meaning each cell has one type of CP for all subframes on a carrier. Downlink and uplink may have different CP types (e.g., normal CP for downlink and extended CP for uplink). For Multimedia Broadcast Single Frequency Network (MBSFN) subframes, the control region may have a normal CP, while the MBSFN region may be extended CP-if it is actually used for Multimedia Broadcast and Multicast Service (MBMS) service.

In some cases, it may be desirable to make the CP “subframe-dependent” for UL CoMP operation. For example, one uplink subframe may have a normal CP (e.g., for UEs not involved in CoMP), and another uplink subframe may have an extended CP (e.g., particularly for UEs involved in CoMP)

### Different CP Configurations

According to certain aspects provided herein, different CPs may be used within the same subframe. For example, some UEs may use the normal CP in a subframe, while other UEs use the extended CP in a subframe, and still other UEs use both normal and extended CPs in the same subframe.

As will be described in greater detail herein, the CP type may also depend on the channel type and the characteristics of the channel. For example, extended CP may be used for control, while normal CP is used for data. In some cases, a first CP type may be used with allocations above a first threshold level, while a second CP type may be used with allocations below a second threshold level. For example, extended CP may be used for channels with a single RB (thereby having a very small allocation in frequency), but normal CP for channels with more than one RB.

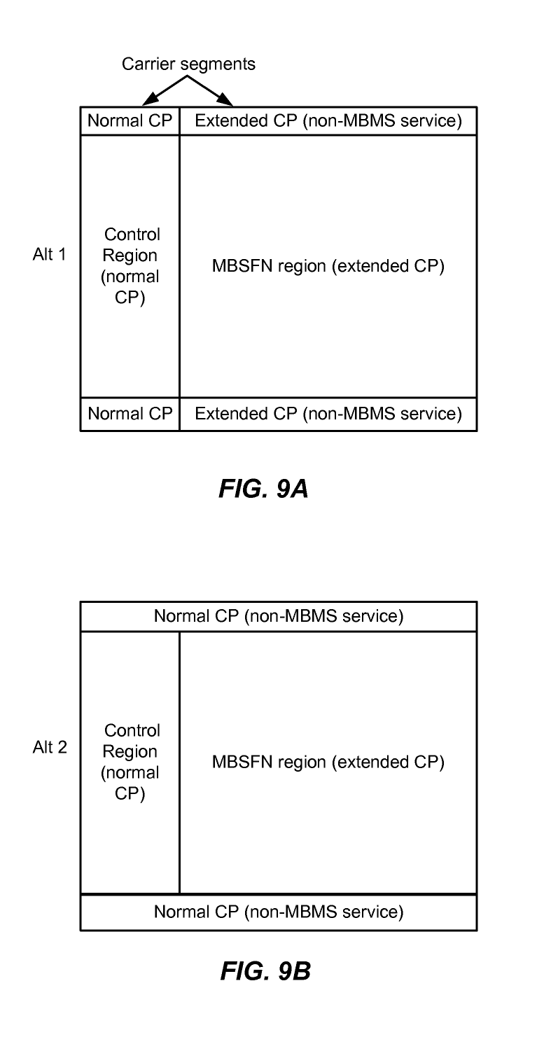

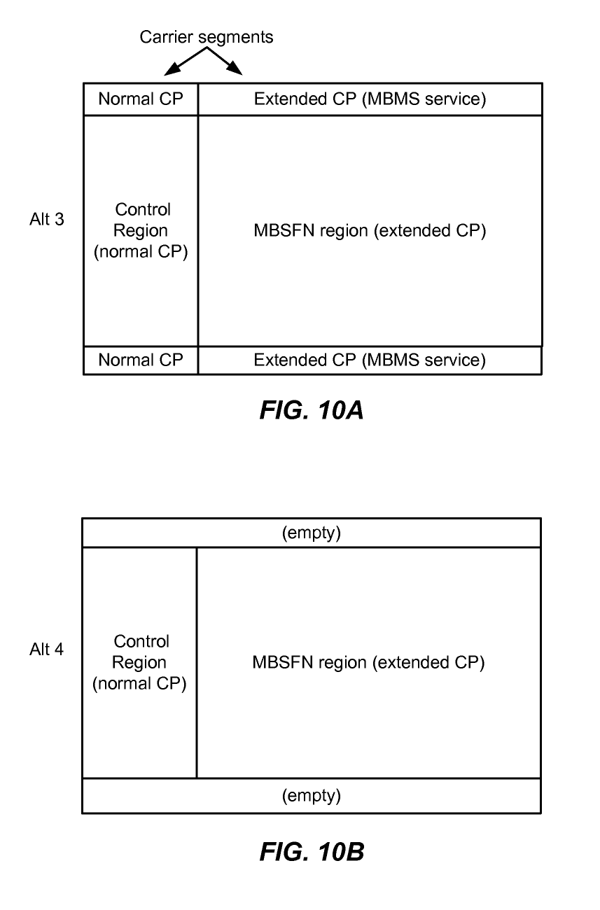

CP type may also depend on the frequency location. For example, in some subbands, a normal CP may be used, while in other subbands, extended CP may be used. For example, in case of carrier segments, normal CP may be used in the anchor carrier, and extended CP may be used in the carrier segments part (as will be described in greater detail below with references to FIGS. 9 and 10). As used, herein, the term carrier segment may generally refer to a bandwidth extensions of an existing (e.g., Rel-8) compatible component carrier. Carrier segments may be limited in size (e.g., no larger than 110 RBs total, and may be considered a complement to carrier aggregation techniques.

CP type may also be UE-specific, for example. Different UEs may use different CP types within the same subframe. CP type can further depend on subframe. For example, in one configuration only a limited set of subframes may contain both the normal and extended CP, while other subframes may only have one CP type, normal or extended CP (but not both). The configuration may be enabled for one link (downlink or uplink) separately, or for two links jointly.

Determination of the CP type may be made either via signaling or it may be predetermined For example, signaling may be made via radio resource control (RRC) signaling or via some control channel. In another example, CP type may be fixed at a desired value based on subframe index, subband location, or channel type.

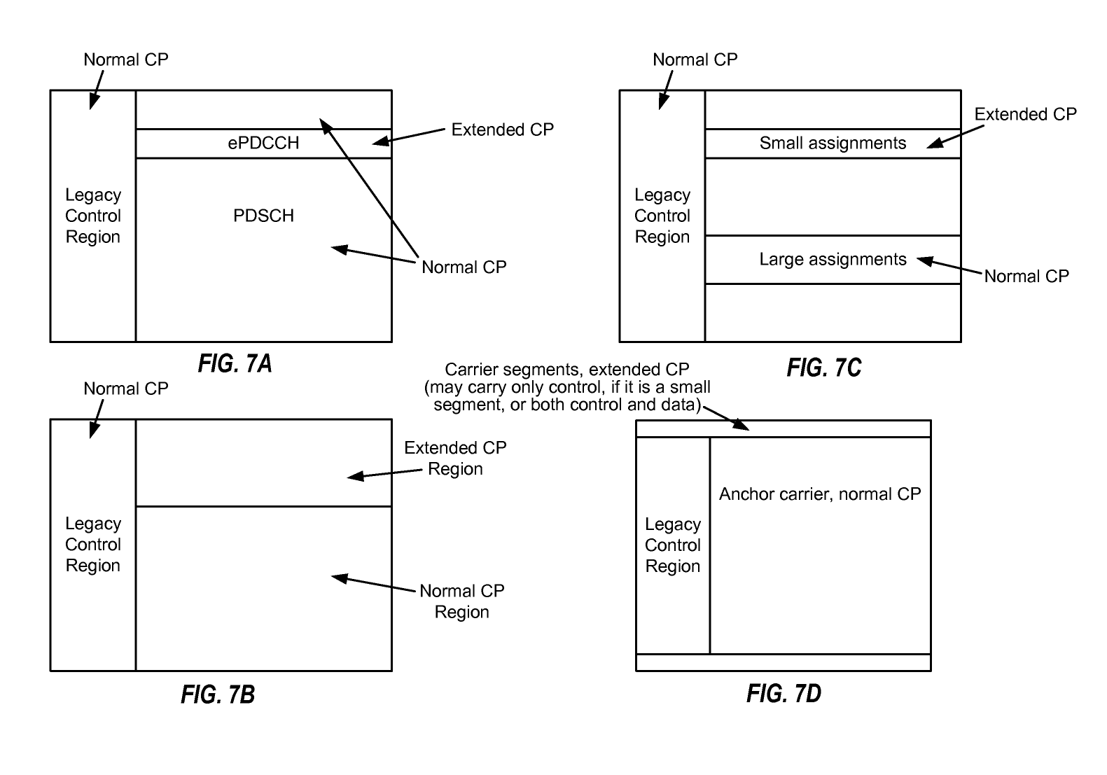

Downlink subframes contain both control and data regions and different CP types may be used in different regions and/or different portions of each region. FIGS. 7A-D illustrate examples of flexible CP management on the downlink. Further, different CP types may be used for different types of control regions, for example, with one CP type for a wide-band legacy control region and another for a narrow-band enhanced physical downlink control channel (ePDCCH).

For example, FIG. 7A shows using an extended CP for the ePDCCH, but using a normal CP for the legacy control region and for the physical downlink shared channel (PDSCH). FIG. 7B shows using extended CP for a region with small RB assignments (for example, 1 RB), but using normal CP for a legacy control region and a region with large RB assignments (multiple RBs). FIG. 7C shows using an extended CP for a first set of frequency locations or subbands, but using a normal CP for the legacy control region and in a second set of frequency locations or subbands. FIG. 7D shows using a normal CP in an anchor carrier, but using an extended CP in carrier segments.

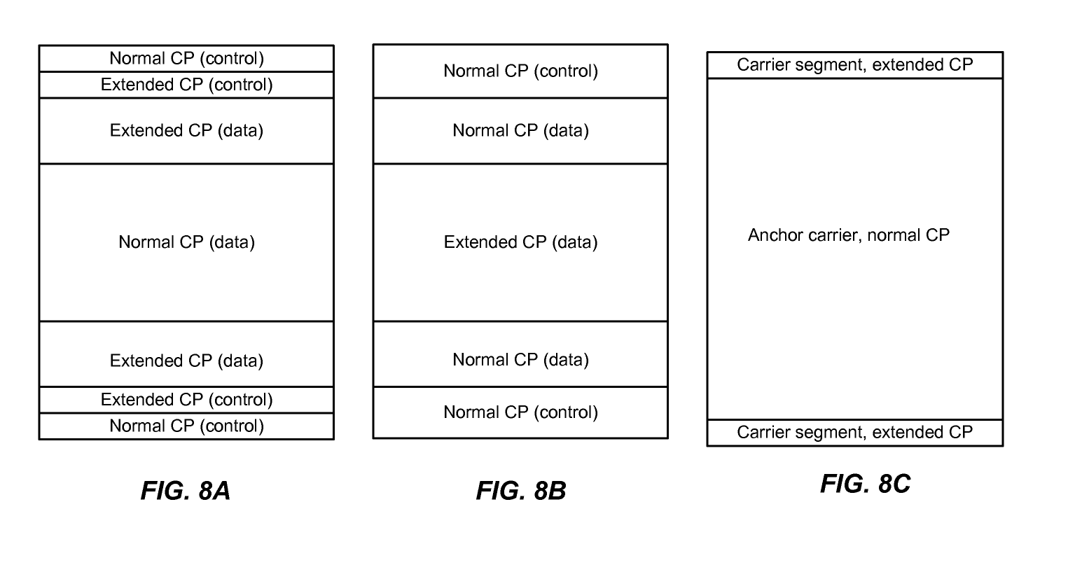

As illustrated in FIGS. 8A-8C, different CP types may also be used for different portions of an uplink subframe. For example, FIG. 8A shows using extended CP for a first part of the control region and a first part of the data region and using normal CP for a second part of the control channel and a second part of the data region. FIG. 8B shows using extended CP for a first part of the data region and using normal CP for the control region and a second part of the data region. FIG. 8C shows using extended CP for some frequency locations or subbands (carrier segments), but using normal CP for an anchor carrier region.

Flexible CP management (utilizing different CP types) in one subframe may add complexity to eNB and UE implementation. For example, on the DL, the eNB may need to use two or more IFFT operations, and the UE may need to use different filters/FFT for channels of different CPs. Similar complexity may exist for the UL.

In some cases, a particular CP configuration may be chosen in an effort to minimize additional complexity. For example, the CP management configurations shown in FIGS. 7C and 7D may be preferable compared with the in FIGS. 7A and 7B, due to a reduced complexity. Extended CP may be the same as currently defined (legacy) extended CP or may be a new CP, for example, with a longer duration than the current normal CP and possibly an even longer duration than legacy extended CP. In still another example, extended CP may have a value between the value used for the normal CP and extended CP in LTE release 10. In still another example, more than two CP types may be managed by a cell in one or more subframes.

In carrier aggregation for LTE Rel-10, the CP type may be separately controlled for different component carriers. The same or different CP types may exist for different carriers. There is typically no signaling of CP type of one carrier from another carrier. The UE, thus, performs CP detection separately for each carrier.

In LTE, carrier segments may be introduced. If single (I)FFT operation is possible, it may be desirable to have the carrier segments share the same CP as the anchor carrier. For example, if the segments are contiguous in frequency with the anchor carrier, the segments and the anchor carrier may use the same CP type. Also, a single control may assign PDSCH resources spanning both the legacy region and the segments region using the same CP type.

In some cases, it may be possible to have a different CP on the carrier segments. In such cases, it may be preferable that such information is available to the UE, for example, via explicit (e.g., RRC) signaling or implicit signaling that the carrier segments and the anchor carrier are using a different CP type. For example, implicit signaling may be done by associating with the subframe type at the anchor carrier, as illustrated in FIGS. 9A and 9B described below.

Flexible CP management may also be applied to handle Multicast/Broadcast Single-Frequency Network (MBSFN) Subframes. FIGS. 9A-B and 10A-10B illustrate example techniques for cyclic prefix management for carrier segments of Multimedia Broadcast Single Frequency Network (MBSFN).

The anchor carrier may configure MBSFN subframes. With multi-cell broadcast that occurs, the same information may be transmitted from multiple cells. By synchronizing transmission timing between cells along with transmitting identical signals from multiple cell sites, the UE will receive a signal which appears to be transmitted from a single cell site and which is subject to multi-path propagation. Since OFDM is robust to multi-path propagation, the received signal strength is improved and inter-cell interference is reduced. As illustrated in FIG. 9A, an MBSFN subframe comprises a control region with a length of one or two OFDM symbols and an MBSFN region whose contents and structure depends on its usage. When these subframes carry multi-media broadcast multimedia services (MBMS) services, how to handle the CP management for the carrier segments in these subframes poses a challenge. Various techniques are presented herein for CP management in MBSFN subframes.

According to a first technique, the carrier segments may carry non-MBMS traffic and use extended CP for non-MBMS service, and use normal CP in the control region. In addition, extended CP may be used in the MBSFN region or data region of the anchor carrier and normal CP may be used in the control region of the anchor carrier, as illustrated in FIG. 9A.

Examples of non-MBMS traffic may include PDSCH, PDCCH, ePDCCH, or the like. Advantages of this technique may include allowing single (I)FFT operation. However, the UE-RS pattern (in the MBSFN region) may follow the pattern defined for the extended region, resulting in dynamic switching of UE-RS pattern defined for normal CP (in non-MBSFN subframes) and extended CP (in MBSFN subframes carrying MBMS).

According to a second technique, the carrier segments may carry non-MBMS traffic, and also use normal CP for the non-MBMS service and use normal CP in the control region. In addition, extended CP may be used in the MBSFN region or data region of the anchor carrier and normal CP may be used in the control region of the anchor carrier, as illustrated in FIG. 9B. Advantages of this technique may include an avoidance of dynamic switching of UE-RS patterns. However, a need for two (I)FFT operations increases complexity.

According to a third technique, the carrier segments carry MBMS traffic, and also use normal CP in the control region and extended CP is used in the MBSFN region of the anchor carrier, while the control region of the anchor carrier uses normal, as illustrated in FIG. 10A. Advantages of this alternative may, again, include a single (I)FFT operation. No non-MBMS traffic (e.g., unicast service), however, may be allowed in the carrier segments and the MBMS traffic in the carrier segments may only be accessible to new (non-legacy) UEs.

According to a fourth technique, the carrier segments may be empty. In the anchor carrier region, normal CP may be used in the control region and extended CP in the data or MBSFN region, as illustrated in FIG. 10B. Advantages of this alternative include a single (I)FFT operation, however, presence of non-usable segments in these subframes may reduce resource efficiency.

According to certain aspects, two or more design alternatives described above may be available. In such cases, a UE may be required to be informed through RRC or PDCCH signaling of the alternative in use for the UE.

According to certain aspects, the design alternatives described above may be used by a cell of a legacy carrier type or a new carrier type. A new carrier type may not contain a legacy control region and may not transmit cell specific reference signals (CRS) in all subframes. In addition, the bandwidth of CRS may be less a downlink system bandwidth of a given cell.

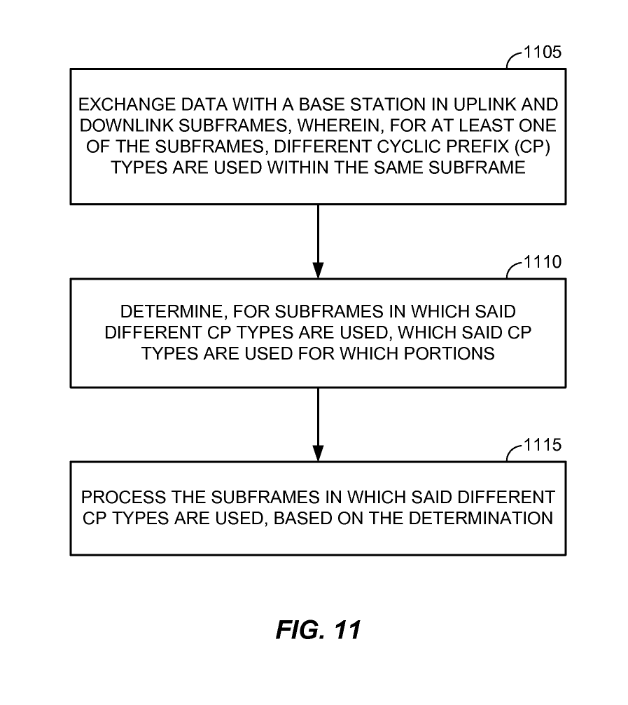

FIG. 11 illustrates example operations 1100 according to certain aspects of the present disclosure. Operations illustrated by the example method 1100 may be executed, for example, by the processor 380 of the UE 120 from FIG. 3.

The operation may begin, at block 1102, by exchanging data with a base station in uplink and downlink subframes, wherein, for at least one of the subframes, different cyclic prefix (CP) types are used within the same subframe. At block 1104, for subframes in which said different CP types are used, which said CP types are used for which portions may be determined At step 1106, the subframes in which said different CP types are used may be processed based on the determination.

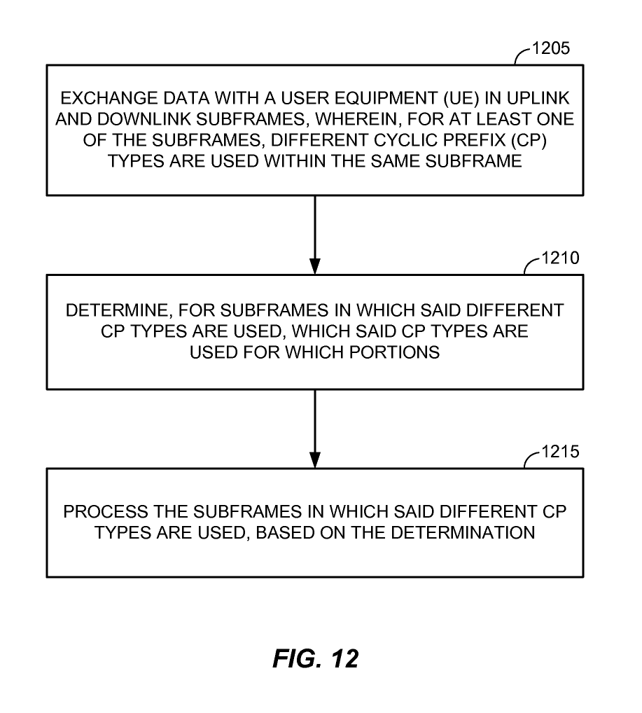

FIG. 12 illustrates example operations 1200 according to certain aspects of the present disclosure. Operations illustrated by the example method 1200 may be executed, for example, by the processor 340 of the base station 110 from FIG. 3.

The operation may begin, at block 1202, by exchanging data with a UE in uplink and downlink subframes, wherein, for at least one of the subframes, different cyclic prefix (CP) types are used within the same subframe. At block 1204, for subframes in which said different CP types are used, which said CP types are used for which portions may be determined At step 1206, the subframes in which said different CP types (e.g., a first CP type and second CP type) are used may be processed based on the determination.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communications, comprising:
exchanging data with a base station in uplink and downlink subframes, wherein, for at least one of the subframes, different cyclic prefix (CP) types are used within the same subframe;
determining, for subframes in which said different CP types are used, which said CP types are used for which portions; and
processing the subframes in which said different CP types are used, based on the determination.

2. The method of claim 1, wherein:
within the same subframe, some user equipments (UEs) use a first CP type and other UEs use a second CP type longer than the first CP type.

3. The method of claim 2, wherein:
the first CP type is used for channels having frequency allocations at or above a first threshold level; and
the second CP type is used for channels having frequency allocations at or below a second threshold level.

4. The method of claim 1, wherein:
said CP type, for different portions of the subframes in which different CP types are used, is dependent on a type of channel conveyed in the portions.

5. The method of claim 4, wherein:
a first said CP type is used for data channels; and
a second said CP type, longer than the first CP type, is used for control channels.

6. The method of claim 1, wherein:
said CP type, for different portions of the subframes in which different CP types are used, is dependent on frequency location of the portions.

7. The method of claim 6, wherein:
a first said CP type is used for frequency locations corresponding to an anchor carrier; and
a second said CP type, longer than the first CP type, is used for frequency locations corresponding to carrier segments.

8. The method of claim 1, wherein:
different said CP types are used in only a limited set of subframes.

9. The method of claim 1, wherein the determining further comprises:
receiving signaling, from the base station.

10. The method of claim 1, wherein the determining comprises:
implicitly determining CP types based on at least one of a subframe index, a subband location, or a channel type.

11. The method of claim 1, wherein different CP types are used for different component carriers.

12. The method of claim 1, wherein different CP types are used in uplink subframes than in the downlink subframes.

13. The method of claim 1, wherein different said CP types are used for Multimedia Broadcast Single Frequency Network (MBSFN) subframes.

14. The method of claim 13, wherein:
a first CP type is used for portions of the MBSFN subframe that carry non-Multimedia Broadcast and Multicast Service (non-MBMS) traffic; and
a second CP type, longer than the first CP type, is used for at least some portions of the MBSFN subframe that carry MBMS traffic.

15. The method of claim 14, wherein:
carrier segments carry non-MBMS traffic and use the first CP type in a control region and the second CP type an MBSFN region.

16. The method of claim 14, wherein:
carrier segments carry non-MBMS traffic and use the first CP type in both an MBSFN region and a control region.

17. The method of claim 14, wherein:
carrier segments carry MBMS traffic and use the first CP type in a control region and the second CP type in an MBSFN region.

18. The method of claim 14, wherein:
carrier segments for the MBSFN subframes are empty.

19. A method for wireless communication, comprising:
exchanging data with a user equipment (UE) in uplink and downlink subframes, wherein, for at least one of the subframes, different cyclic prefix (CP) types are used within the same subframe;
determining, for subframes in which said different CP types are used, which said CP types are used for which portions; and
processing the subframes in which said different CP types are used, based on the determination.

20. The method of claim 19, wherein:
within the same subframe, some user equipments (UEs) use a first CP type and other UEs use a second CP type longer than the first CP type.

21. The method of claim 20, wherein:
the first CP type is used for channels having frequency allocations at or above a first threshold level; and
the second CP type is used for channels having frequency allocations at or below a second threshold level.

22. The method of claim 19, wherein:
said CP type, for different portions of the subframes in which different CP types are used, is dependent on a type of channel conveyed in the portions.

23. The method of claim 22, wherein:
a first said CP type is used for data channels; and
a second said CP type, longer than the first CP type, is used for control channels.

24. The method of claim 19, wherein:
said CP type, for different portions of the subframes in which different CP types are used, is dependent on frequency location of the portions.

25. The method of claim 24, wherein:
a first CP type is used for frequency locations corresponding to an anchor carrier; and
a second CP type, longer than the first CP type, is used for frequency locations corresponding to carrier segments.

26. The method of claim 19, wherein:
different said CP types are used in only in a limited set of subframes.

27. The method of claim 19, further comprising:
signaling, to the UE, information regarding, for subframes in which said different CP types are used, which said CP types are used for which portions.

28. The method of claim 19, wherein the UE implicitly determines, for subframes in which said different CP types are used, which said CP types are used for which portions based at least one of a subframe index, transmitting on a subband location, or transmitting a particular channel type.

29. The method of claim 19, wherein different CP types are used for different component carriers.

30. The method of claim 19, wherein different CP types are used in uplink subframes than the downlink subframes.

31. The method of claim 19, wherein different said CP types are used for Multimedia Broadcast Single Frequency Network (MBSFN) subframes.

32. The method of claim 31, wherein:
a first CP type is used for portions of the MBSFN subframe that carry non-Multimedia Broadcast and Multicast Service (non-MBMS) traffic; and
a second CP type, longer than the first CP type, is used for at least some portions of the MBSFN subframe that carry MBMS traffic.

33. The method of claim 32, wherein:
carrier segments carry non-MBMS traffic and use the first CP type in a control region and the second CP type an MBSFN region.

34. The method of claim 32, wherein:
carrier segments carry non-MBMS traffic and use the first CP type in both an MBSFN region and a control region.

35. The method of claim 32, wherein:
carrier segments carry MBMS traffic and use the first CP type in a control region and the second CP type in an MBSFN region.

36. The method of claim 32, wherein:
carrier segments for the MBSFN subframes are empty.

37. A user equipment, comprising:
at least one processor; and
a memory coupled to said at least one processor, wherein said at least one processor is configured to exchange data with a base station in uplink and downlink subframes, wherein, for at least one of the subframes, different cyclic prefix (CP) types are used within the same subframe, determine, for subframes in which said different CP types are used, which said CP types are used for which portions, and process the subframes in which said different CP types are used, based on the determination.

38. The user equipment of claim 37, wherein:
within the same subframe, some user equipments (UEs) use a first CP type and other UEs use a second CP type longer than the first CP type.

39. The user equipment of claim 38, wherein:
the first CP type is used for channels having frequency allocations at or above a first threshold level; and
the second CP type is used for channels having frequency allocations at or below a second threshold level.

40. The user equipment of claim 37, wherein:
said CP type, for different portions of the subframes in which different CP types are used, is dependent on a type of channel conveyed in the portions.

41. The user equipment of claim 40, wherein:
a first said CP type is used for data channels; and
a second said CP type, longer than the first CP type, is used for control channels.

42. The user equipment of claim 37, wherein:
said CP type, for different portions of the subframes in which different CP types are used, is dependent on frequency location of the portions.

43. The user equipment of claim 42, wherein:
a first said CP type is used for frequency locations corresponding to an anchor carrier; and
a second said CP type, longer than the first CP type, is used for frequency locations corresponding to carrier segments.

44. The user equipment of claim 37, wherein:
different said CP types are used in only a limited set of subframes.

45. The user equipment of claim 37, wherein the at least one processor is further configured to:
receive signaling, from the base station.

46. The user equipment of claim 37, wherein the at least one processor is configured to:
implicitly determine CP types based on at least one of a subframe index, a subband location, or a channel type.

47. The user equipment of claim 37, wherein different CP types are used for different component carriers.

48. The user equipment of claim 37, wherein different CP types are used in uplink subframes than in the downlink subframes.

49. The user equipment of claim 37, wherein different said CP types are used for Multimedia Broadcast Single Frequency Network (MBSFN) subframes.

50. The user equipment of claim 49, wherein:
a first CP type is used for portions of the MBSFN subframe that carry non-Multimedia Broadcast and Multicast Service (non-MBMS) traffic; and
a second CP type, longer than the first CP type, is used for at least some portions of the MBSFN subframe that carry MBMS traffic.

51. The user equipment of claim 50, wherein:
carrier segments carry non-MBMS traffic and use the first CP type in a control region and the second CP type an MBSFN region.

52. The user equipment of claim 50, wherein:
carrier segments carry non-MBMS traffic and use the first CP type in both an MBSFN region and a control region.

53. The user equipment of claim 50, wherein:
carrier segments carry MBMS traffic and use the first CP type in a control region and the second CP type in an MBSFN region.

54. The user equipment of claim 50, wherein:
carrier segments for the MBSFN subframes are empty.

55. A base station, comprising:
at least one processor; and
a memory coupled to said at least one processor, wherein said at least one processor is configured to exchange data with a user equipment (UE) in uplink and downlink subframes, wherein, for at least one of the subframes, different cyclic prefix (CP) types are used within the same subframe, determine, for subframes in which said different CP types are used, which said CP types are used for which portions, and process the subframes in which said different CP types are used, based on the determination.

56. The base station of claim 55, wherein:
within the same subframe, some user equipments (UEs) use a first CP type and other UEs use a second CP type longer than the first CP type.

57. The base station of claim 56, wherein:
the first CP type is used for channels having frequency allocations at or above a first threshold level; and
the second CP type is used for channels having frequency allocations at or below a second threshold level.

58. The base station of claim 55, wherein:
said CP type, for different portions of the subframes in which different CP types are used, is dependent on a type of channel conveyed in the portions.

59. The base station of claim 58, wherein:
a first said CP type is used for data channels; and
a second said CP type, longer than the first CP type, is used for control channels.

60. The base station of claim 55, wherein:
said CP type, for different portions of the subframes in which different CP types are used, is dependent on frequency location of the portions.

61. The base station of claim 60, wherein:
a first CP type is used for frequency locations corresponding to an anchor carrier; and
a second CP type, longer than the first CP type, is used for frequency locations corresponding to carrier segments.

62. The base station of claim 55, wherein:
different said CP types are used in only in a limited set of subframes.

63. The base station of claim 55, wherein the at least one processor is further configured to:
signal, to the UE, information regarding, for subframes in which said different CP types are used, which said CP types are used for which portions.

64. The base station of claim 55, wherein the UE implicitly determines, for subframes in which said different CP types are used, which said CP types are used for which portions based at least one of a subframe index, transmitting on a subband location, or transmitting a particular channel type.

65. The base station of claim 55, wherein different CP types are used for different component carriers.

66. The base station of claim 55, wherein different CP types are used in uplink subframes than the downlink subframes.

67. The base station of claim 55, wherein different said CP types are used for Multimedia Broadcast Single Frequency Network (MBSFN) subframes.

68. The base station of claim 67, wherein:
a first CP type is used for portions of the MBSFN subframe that carry non-Multimedia Broadcast and Multicast Service (non-MBMS) traffic; and
a second CP type, longer than the first CP type, is used for at least some portions of the MBSFN subframe that carry MBMS traffic.

69. The base station of claim 68, wherein:
carrier segments carry non-MBMS traffic and use the first CP type in a control region and the second CP type an MBSFN region.

70. The base station of claim 68, wherein:
carrier segments carry non-MBMS traffic and use the first CP type in both an MBSFN region and a control region.

71. The base station of claim 68, wherein:
carrier segments carry MBMS traffic and use the first CP type in a control region and the second CP type in an MBSFN region.

72. The base station of claim 68, wherein:
carrier segments for the MBSFN subframes are empty.

73. An apparatus for wireless communications, comprising:
means for exchanging data with a base station in uplink and downlink subframes, wherein, for at least one of the subframes, different cyclic prefix (CP) types are used within the same subframe;
means for determining, for subframes in which said different CP types are used, which said CP types are used for which portions; and
means for processing the subframes in which said different CP types are used, based on the determination.

74. An apparatus for wireless communication, comprising:
means for exchanging data with a user equipment (UE) in uplink and downlink subframes, wherein, for at least one of the subframes, different cyclic prefix (CP) types are used within the same subframe;
means for determining, for subframes in which said different CP types are used, which said CP types are used for which portions; and
means for processing the subframes in which said different CP types are used, based on the determination.

75. A computer program product comprising a non-transitory computer readable medium having instructions stored thereon, the instructions executable by one or more processors for:
exchanging data with a base station in uplink and downlink subframes, wherein, for at least one of the subframes, different cyclic prefix (CP) types are used within the same subframe;
determining, for subframes in which said different CP types are used, which said CP types are used for which portions; and
processing the subframes in which said different CP types are used, based on the determination.

76. A computer program product comprising a non-transitory computer readable medium having instructions stored thereon, the instructions executable by one or more processors for:
exchanging data with a user equipment in uplink and downlink subframes, wherein, for at least one of the subframes, different cyclic prefix (CP) types are used within the same subframe;
determining, for subframes in which said different CP types are used, which said CP types are used for which portions; and
processing the subframes in which said different CP types are used, based on the determination.
